(19) United States
(12) Patent Application Publication
(10) Pub. No.: US 2024/0019235 A1
(43) Pub. Date: Jan. 18, 2024

(54) END OF HOSE MIXING SYSTEMS AND METHODS

(71) Applicant: Dyno Nobel Asia Pacific Pty Limited, Southbank, Victoria (AU)

(72) Inventors: Bernhard de Vries, Singleton, New South Wales (AU); Jamie Budd, Singleton, New South Wales (AU); Verlene Lovell, Salt Lake City, UT (US); Savas Samat, Singleton, New South Wales (AU)

(21) Appl. No.: 18/252,513

(22) PCT Filed: Nov. 9, 2021
(86) PCT No.: PCT/AU2021/051319

§ 371 Date: May 10, 2023

(30) Foreign Application Priority Data
Nov. 10, 2020 (AU) 2020904106

(51) Int. Cl. F42D 1/10; F42D 3/04; B01F 23/232; B01F 25/431

(52) U.S. Cl. CPC F42D 1/10; F42D 3/04; B01F 23/232; B01F 25/431; B01F 2215/0427; B01F 2101/34

(57) ABSTRACT

An end of hose mixing system for development charging may include a static mixer disposed near the end of a delivery apparatus. The mixing system may include a mixing tube with a central bore, and the mixing tube is coupled to an outlet of a delivery hose. The mixing tube includes a static mixer disposed within the central bore of the mixing tube. The spray nozzle system further includes a nozzle with a central bore, and the nozzle is coupled to the mixing tube outlet. The static mixer may be disposed within a delivery hose itself. The static mixer may be disposed a predetermined distance from a distal end of the delivery apparatus to establish laminar flow of an emulsion after the emulsion is mixed with a sensitizing agent by the static mixer. The sensitized emulsion may be expelled from the delivery apparatus at an angle less than 45 degrees.

### RELATED APPLICATIONS

This application claims priority to Australian Provisional Patent Application No. 2020904106, entitled END OF HOSE MIXING SYSTEMS AND METHODS, filed Nov. 10, 2020, which is hereby incorporated by reference in its entirety.

### TECHNICAL FIELD

The present disclosure relates generally to the field of explosives. More specifically, the present disclosure relates to systems for delivery of explosives and methods related thereto. In some embodiments, the apparatus and method are related to development charging.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 illustrates a side view of one embodiment of a mobile processing unit equipped with an explosives delivery system that includes a spray nozzle system coupled to a delivery conduit inserted into a horizontal blasthole.

FIG. 2 illustrates a perspective view of a spray nozzle system according to one embodiment of the present disclosure.

FIG. 3 illustrates a cross-sectional view of the spray nozzle system of FIG. 3.

FIG. 4 illustrates a mixing tube of a spray nozzle system according to one embodiment of the present disclosure.

FIG. 5 illustrates a cross-sectional view of the mixing tube of FIG. 4.

FIG. 6 illustrates a perspective view of a static mixer according to one embodiment.

FIG. 7 illustrates a perspective view of a static mixer according to one embodiment.

FIG. 8 illustrates a nozzle of a spray nozzle system according to one embodiment.

FIG. 9 illustrates a cross-sectional view of the nozzle of FIG. 8.

FIG. 10 illustrates a process flow diagram of a system for delivery of explosives according to one embodiment of the present disclosure.

FIG. 11 illustrates a static mixer according to one embodiment of the present disclosure.

FIG. 12A illustrates a static mixer according to one embodiment of the present disclosure.

FIG. 12B illustrates the static mixer of FIG. 12A disposed within a mixing device, according to one embodiment of the present disclosure.

### DETAILED DESCRIPTION

Emulsion explosives are commonly used in the mining, quarrying, and excavation industries for breaking rocks and ore. Generally, a hole, referred to as a “blasthole,” is drilled in a surface, such as the ground. In development charging, a plurality of horizontal holes may be drilled into a rock face. Emulsion explosives may then be pumped or augured into the plurality of blastholes. The resulting explosion of the emulsion explosives in the plurality of blastholes creates a horizontal mining tunnel.

Emulsion explosives are generally transported to a job site as an emulsion matrix that is too dense to completely detonate. In general, the emulsion matrix needs to be “sensitized” in order for the emulsion explosive to detonate successfully. Sensitizing is often accomplished by introducing a sensitizing agent that either provides or generates small voids into the emulsion matrix. These voids reduce the density of the emulsion explosive and also act as hot spots for propagating detonation. The sensitizing agent may be gas bubbles introduced by blowing a gas into the emulsion matrix, hollow microspheres or other porous media, and/or chemical gassing agents that are injected into and react with the emulsion matrix and thereby form gas bubbles. With chemical gassing agents, a certain amount of time is generally required before “gassing” is complete. For purposes of this disclosure, once a sensitizing agent is fully mixed with an emulsion matrix, the resulting emulsion is considered an emulsion explosive and sensitized, even though sensitization may not be complete for a certain amount of time.

For blastholes, depending upon the length, detonators may be placed at the end, also referred to as the “toe,” of the blasthole and at the beginning of the emulsion explosives. Often, in such situations, the open end of the blasthole will not be filled with explosives, but will be filled with an inert material, referred to as “stemming,” to try and keep the force of an explosion within the material surrounding the blasthole, rather than allowing explosive gases and energy to escape out of the open end of the blasthole.

Systems for delivering explosives and methods related thereto are disclosed herein. It will be readily understood that the components of the embodiments as generally described below and illustrated in the Figures herein could be arranged and designed in a wide variety of different configurations. Thus, the following more detailed description of various embodiments, as described below and represented in the Figures, is not intended to limit the scope of the disclosure, but is merely representative of various embodiments. While the various aspects of the embodiments are presented in drawings, the drawings are not necessarily drawn to scale unless specifically indicated.

The phrase “coupled to” refers to any form of interaction between two or more entities, including mechanical, electrical, magnetic, electromagnetic, fluid, and thermal interaction. Likewise, “fluidically connected to” refers to any form of fluidic interaction between two or more entities. Two entities may interact with each other even though they are not in direct contact with each other. For example, two entities may interact with each other through an intermediate entity.

The term “substantially” is used herein to mean almost and including 100%, including at least about 80%, at least about 90%, at least about 91%, at least about 92%, at least about 93%, at least about 94%, at least about 95%, at least about 96%, at least about 97%, at least about 98%, and at least about 99%.

The term “proximal” is used herein to refer to “near” or “at” the object disclosed. For example, “proximal the outlet of the delivery conduit” refers to near or at the outlet of the delivery conduit.

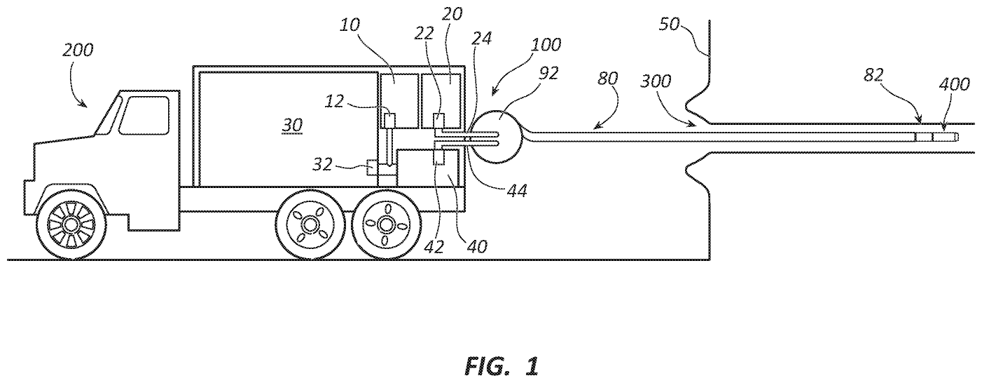

FIG. 1 illustrates an exemplary explosives delivery system 100 for development blast charging. As discussed above, development blast charging refers to the development of mining tunnels by creating a plurality of horizontal blastholes in a rock face 50. For brevity, the present disclosure focuses on development blast charging; however, the explosives delivery system 100 discussed in the present disclosure may be used in a number of different types of blast charging, such as vertical blast charging, production blasting, and the like.

FIG. 1 illustrates a side view of one embodiment of a mobile processing unit 200 equipped with the explosives delivery system 100. The mobile processing unit 200 may be configured to go underground. The mobile processing unit 200 may include a first reservoir 10, a second reservoir 20, a third reservoir 30, and a homogenizer 40 mounted to the mobile processing unit 200. Different types of blast charging may use some but not all of the components listed above. For example, in some embodiments, the first reservoir 10, the second reservoir 20, the homogenizer 40, and combinations thereof may be optional components. The mobile processing unit 200 is positioned near a horizontal development blasthole 300. For simplicity, a single horizontal development blasthole 300 is illustrated, but a plurality of horizontal blastholes may be drilled into the rock face 50.

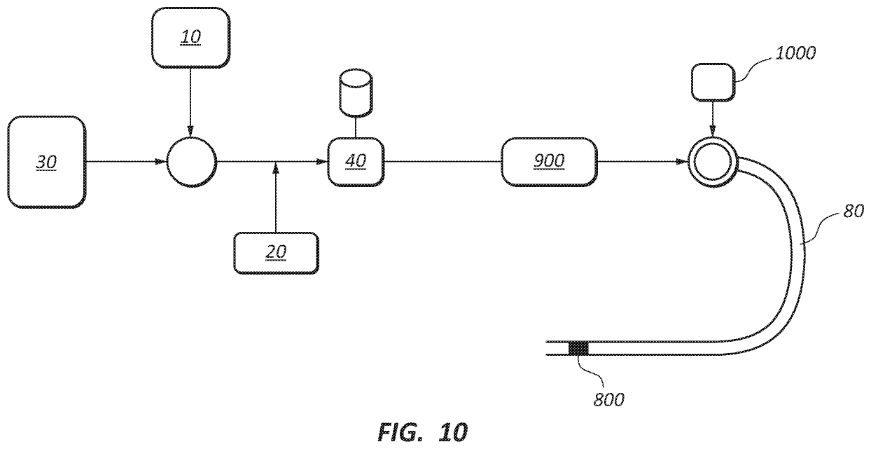

In some embodiments, the first reservoir 10 is configured to store a first gassing agent (such as a pH control agent), the second reservoir 20 is configured to store a second gassing agent (such as a chemical gassing agent), and the third reservoir 30 is configured to store an emulsion matrix. The homogenizer 40 is configured to mix the emulsion matrix, the first gassing agent, and optionally the second gassing agent into a substantially homogenized emulsion matrix. For example, in FIG. 1, the second gassing agent is introduced after the homogenizer 40; however, in FIG. 10, the second gassing agent is introduced before the homogenizer 40.

In some embodiments, the first gassing agent comprises a pH control agent. The pH control agent may comprise an acid. Examples of acids include, but are not limited to, organic acids such as citric acid, acetic acid, and tartaric acid. Any pH control agent known in the art and compatible with the second gassing agent and gassing accelerator, if present, may be used. The pH control agent may be dissolved in an aqueous solution.

In some embodiments, the second gassing agent comprises a chemical gassing agent configured to react in an emulsion matrix and with a gassing accelerator, if present. Examples of chemical gassing agents include, but are not limited to, peroxides such as hydrogen peroxide, inorganic nitrite salts such as sodium nitrite, nitrosamines such as N,N′-dinitrosopentamethylenetetramine, alkali metal borohydrides such as sodium borohydride, and bases such as carbonates including sodium carbonate. Any chemical gassing agent known in the art and compatible with the emulsion matrix and the gassing accelerator, if present, may be used. The chemical gassing agent may be dissolved in an aqueous solution and stored in the second reservoir 20.

In some embodiments, second reservoir 20 is further configured to store a gassing accelerator mixed with the second gassing agent. Alternatively, the gassing accelerator may be stored in a separate reservoir or not present in the system. Examples of gassing accelerators include, but are not limited to, thiourea, urea, thiocyanate, iodide, cyanate, acetate, sulphonic acid and its salts, and combinations thereof. Any gassing accelerator known in the art and compatible with the first gassing agent and the second gassing agent may be used. The pH control agent, the chemical gassing agent, and the gassing accelerator may each be dissolved in an aqueous solution.

In some embodiments, the emulsion matrix comprises a continuous fuel phase and a discontinuous oxidizer phase. Any emulsion matrix known in the art may be used, such as, by way of non-limiting example, the Titan® 1000 G from Dyno Nobel.

Examples of the fuel phase include, but are not limited to, liquid fuels such as fuel oil, diesel oil, distillate, furnace oil, kerosene, gasoline, and naphtha; waxes such as microcrystalline wax, paraffin wax, and slack wax; oils such as paraffin oils, benzene, toluene, and xylene oils, asphaltic materials, polymeric oils such as the low molecular weight polymers of olefins, animal oils, such as fish oils, and other mineral, hydrocarbon or fatty oils; and mixtures thereof. Any fuel phase known in the art and compatible with the oxidizer phase and an emulsifier, if present, may be used.

The emulsion matrix may provide at least about 95%, at least about 96%, or at least about 97% of the oxygen content of the sensitized product.

Examples of the oxidizer phase include, but are not limited to, oxygen-releasing salts. Examples of oxygen-releasing salts include, but are not limited to, alkali and alkaline earth metal nitrates, alkali and alkaline earth metal chlorates, alkali and alkaline earth metal perchlorates, ammonium nitrate, ammonium chlorate, ammonium perchlorate, and mixtures thereof, such as a mixture of ammonium nitrate and sodium or calcium nitrates. Any oxidizer phase known in the art and compatible with the fuel phase and an emulsifier, if present, may be used. The oxidizer phase may be dissolved in an aqueous solution, resulting in an emulsion matrix known in the art as a “water-in-oil” emulsion. The oxidizer phase may not be dissolved in an aqueous solution, resulting in an emulsion matrix known in the art as a “melt-in-oil” emulsion.

In some embodiments, the emulsion matrix further comprises an emulsifier. Examples of emulsifiers include, but are not limited to, emulsifiers based on the reaction products of poly[alk(en)yl]succinic anhydrides and alkylamines, including the polyisobutylene succinic anhydride (PiBSA) derivatives of alkanolamines. Additional examples of emulsifiers include, but are not limited to, alcohol alkoxylates, phenol alkoxylates, poly(oxyalkylene)glycols, poly(oxyalkylene) fatty acid esters, amine alkoxylates, fatty acid esters of sorbitol and glycerol, fatty acid salts, sorbitan esters, poly(oxyalkylene)sorbitan esters, fatty amine alkoxylates, poly(oxyalkylene)glycol esters, fatty acid amines, fatty acid amide alkoxylates, fatty amines, quaternary amines, alkyloxazolines, alkenyloxazolines, imidazolines, alkylsulphonates, alkylsulphosuccinates, alkylarylsulphonates, alkylphosphates, alkenylphosphates, phosphate esters, lecithin, copolymers of poly(oxyalkylene)glycol and poly(12-hydroxystearic) acid, 2-alkyl and 2-alkenyl-4,4′-bis(hydroxymethyl)oxazoline, sorbitan mono-oleate, sorbitan sesquioleate, 2-oleyl-4,4′bis(hydroxymethyl)oxazoline, and mixtures thereof. Any emulsifier known in the art and compatible with the fuel phase and the oxidizer phase may be used.

The explosives delivery system 100 may further comprise a first pump 12 configured to pump the first gassing agent. The inlet of the first pump 12 is fluidically connected to the first reservoir 10. The outlet of the first pump 12 is fluidically connected to a flowmeter configured to measure a stream of the first gassing agent. The first flowmeter is fluidically connected to the homogenizer 40. The stream of the first gassing agent may be introduced into a stream of the emulsion matrix upstream from the homogenizer 40.

The explosives delivery system 100 may further comprise a second pump 22 configured to pump the second gassing agent. The inlet of the second pump 22 is operably connected to the second reservoir 20. The outlet of the second pump 22 is fluidically connected to a second flowmeter configured to measure the flow in a stream of the second gassing agent. The second flowmeter is fluidically connected to a valve. The valve is configured to control the stream of the second gassing agent. The valve is fluidically connected to a delivery apparatus 80 proximal the outlet of the delivery apparatus 80. The delivery apparatus 80 may have a central bore that extends a length of the delivery apparatus 80 from a proximal end to a distal end 82 of the delivery apparatus 80 and an outlet disposed at the distal end 82. In some embodiments, the delivery apparatus 80 is a delivery hose. The delivery apparatus 80 is configured to deliver an emulsion explosive out of the outlet at the distal end 82 of the delivery apparatus 80.

Explosives delivery system 100 may further comprise a third pump 32 configured to pump the emulsion matrix. The inlet of the third pump 32 is fluidically connected to the third reservoir 30. The outlet of the third pump 32 is fluidically connected to a third flowmeter configured to measure a stream of the emulsion matrix. The third flowmeter is fluidically connected to the homogenizer 40. In embodiments that do not include the homogenizer 40, the third flowmeter, if present, may be fluidically connected to the delivery apparatus 80.

In some embodiments, the explosives delivery system 100 is configured to convey the second gassing agent at a mass flow rate of less than about 5%, less than about 4%, less than about 2%, or less than about 1% of a mass flow rate of the emulsion matrix.

The homogenizer 40 may be configured to homogenize the emulsion matrix when forming the homogenized product. As used herein, “homogenize” or “homogenizing” refers to reducing the size of oxidizer phase droplets in the fuel phase of an emulsion matrix, such as the emulsion matrix. The homogenizing emulsion matrix increases the viscosity of the homogenized emulsion matrix as compared to the unhomogenized emulsion matrix. The homogenizer 40 may also be configured to mix the stream of the emulsion matrix and the stream of the first gassing agent into the homogenized emulsion matrix. The stream of the homogenized emulsion matrix exits the homogenizer 40. Pressure from the stream of the emulsion matrix and the stream of the first gassing agent may supply the pressure for the flowing stream of the homogenized emulsion matrix. The system 100 may comprise a fourth pump 42 that is configured to pump the homogenized emulsion matrix out of the homogenizer 40.

The homogenizer 40 may reduce the size of oxidizer phase droplets by introducing a shearing stress on the emulsion matrix and the first gassing agent. The homogenizer 40 may comprise a valve configured to introduce a shearing stress on the emulsion matrix and the first gassing agent. The homogenizer 40 may further comprise mixing elements, such as, by way of non-limiting example, static mixers and/or dynamic mixers, such as augers, for the mixing stream of the first gassing agent with the stream of emulsion matrix.

Homogenizing the emulsion matrix may be beneficial for the sensitized emulsion. For example, the reduced oxidizer phase droplet size and increased viscosity of sensitized emulsion explosive, as compared to an unhomogenized sensitized emulsion explosive, may mitigate gas bubble coalescence of the gas bubbles generated by introduction of the second gassing agent. Likewise, the effects of static head pressure on gas bubble density in a homogenized sensitized emulsion explosive are reduced as compared to an unhomogenized sensitized emulsion explosive. Therefore, gas bubble migration is less in a homogenized sensitized emulsion explosive as compared to an unhomogenized sensitized emulsion explosive.

In some embodiments, the homogenizer 40 does not substantially homogenize the emulsion matrix. In such embodiments, the homogenizer 40 comprises elements primarily configured to mix the stream of the emulsion matrix and the stream of the first gassing agent, but does not include elements primarily configured to reduce the size of oxidizer phase droplets in the emulsion matrix. In such embodiments, sensitized emulsion explosive would be an unhomogenized sensitized emulsion explosive. “Primarily configured” as used herein refers to the main function that an element was configured to perform. For example, any mixing element(s) of homogenizer 40 may have some effect on oxidizer phase droplet size, but the main function of the mixing elements may be to mix the stream of the first gassing agent and the stream of the emulsion matrix.

The second gassing agent from the second reservoir 20 may be introduced into the emulsion matrix (e.g., the homogenized or the unhomogenized emulsion matrix) in a number of different ways to sensitize the emulsion matrix. For example, the second gassing agent may be introduced via a ring embodiment, a centerline embodiment, or an end of hose embodiment.

In the ring and the centerline embodiments, the second reservoir 20 is configured to store the second gassing agent and an injector that is configured to inject the second gassing agent through a conduit 24 to the delivery apparatus 80. In the ring embodiment, the second gassing agent is injected into the delivery apparatus 80 to lubricate the conveyance of an emulsion matrix (e.g., the homogenized or the unhomogenized emulsion matrix) through the inside of the delivery apparatus 80. The injector may be configured to inject an annulus of the second gassing agent that surrounds the stream of the emulsion matrix and lubricates the flow of the emulsion matrix inside the delivery apparatus 80. The lubricant containing the second gassing agent may also contain water. As the stream of the emulsion matrix is conveyed through the delivery apparatus 80, the second gassing agent may begin to sensitize the emulsion matrix somewhat through diffusion.

In the centerline embodiment, the injector may be configured to inject a centerline stream of the second gassing agent that is within the stream of the emulsion matrix. As the stream of the emulsion matrix is conveyed through the delivery apparatus 80, the second gassing agent may begin to sensitize the emulsion matrix somewhat through diffusion.

In the end of hose embodiment, the second gassing agent is conveyed separately from the emulsion matrix in the delivery apparatus 80 and the second gassing agent is injected into the emulsion matrix before the emulsion explosive is expelled from the delivery apparatus 80 and into the horizontal development blasthole 300. In some embodiments, the second gassing agent is conveyed in the delivery apparatus 80 in a separate tube within a sidewall of the delivery apparatus 80. In an alternative embodiment, a separate tube may be located external to the delivery apparatus 80 for conveying the stream of the second gassing agent. For example, the separate tube may be attached to an outer surface of the delivery apparatus 80.

The delivery apparatus 80 may be unwound from a hose reel 92 and inserted into the horizontal development blasthole 300. The delivery apparatus 80 may further include a spray nozzle system 400 that is disposed at the distal end 82 of the delivery apparatus 80 and is configured to mix the second gassing agent and the emulsion matrix to sensitize the emulsion matrix. The delivery apparatus 80 may be a flexible hose. A conduit 44 fluidically connects the third reservoir 30 and the emulsion matrix to an annulus of the delivery apparatus 80. In some embodiments, the emulsion matrix and the first gassing agent are mixed in the homogenizer 40 and pumped from the homogenizer 40 through the conduit 44 to the annulus of the delivery apparatus 80 to a spray nozzle system 400 disposed at the distal end 82 of the delivery apparatus 80. The stream of emulsion matrix is conveyed through the delivery apparatus 80 in laminar flow until it reaches the spray nozzle system 400. The spray nozzle system 400 is configured to mix the second gassing agent and the emulsion matrix to sensitize the emulsion matrix and to expel the stream of the sensitized emulsion explosive from the delivery apparatus 80 into the horizontal development blasthole 300.

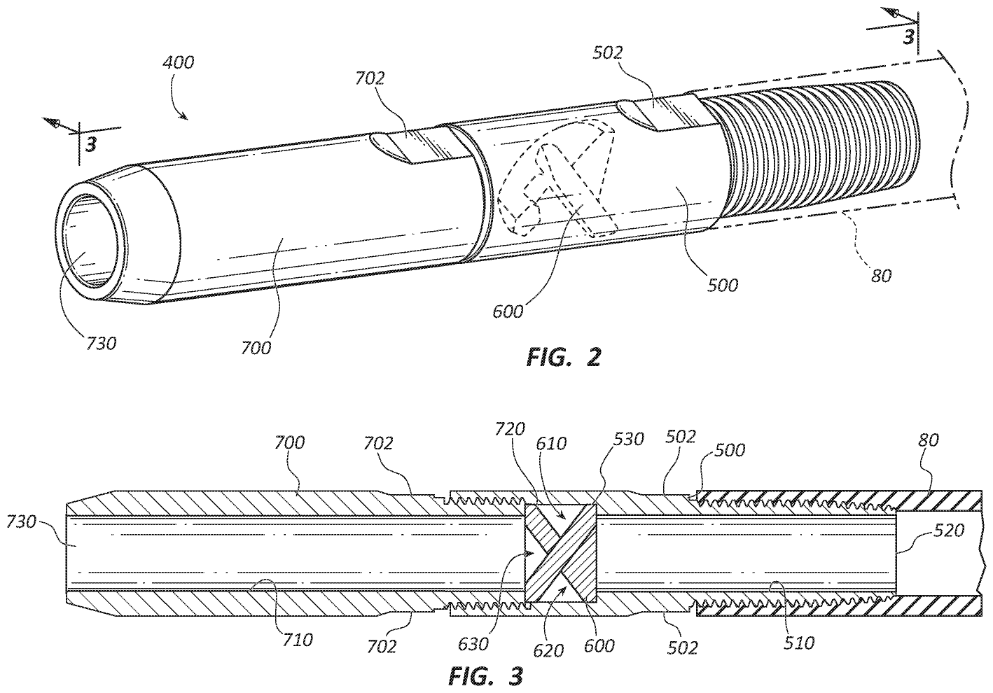

FIGS. 2 and 3 illustrate the spray nozzle system 400 that is coupled to the distal end 82 of the delivery apparatus 80. FIG. 2 illustrates a perspective view of the spray nozzle system 400, and FIG. 3 illustrates a cross-sectional view of the spray nozzle system 400 taken along cross-sectional line 3-3. The spray nozzle system 400 may include a mixing tube 500 and a nozzle 700. The mixing tube 500 comprises a static mixer 600 disposed in a central bore 510 of the mixing tube 500. The central bore 510 extends from a mixing tube inlet 520 to a mixing tube outlet 530. The mixing tube inlet 520 is coupled to the distal end 82 of the delivery apparatus 80 and is detachably attachable to the delivery apparatus 80. The mixing tube outlet 530 may be coupled to the nozzle 700 and is detachably attachable to the nozzle 700.

The emulsion matrix is mixed with the sensitizing agent (e.g., the second gassing agent) by the static mixer 600 in the mixing tube 500. Sensitizing the emulsion matrix decreases the density of the emulsion matrix. In some embodiments, the density of the sensitized emulsion explosive reaches 0.9 g/ml. In some embodiments, the density of the sensitized emulsion explosive is 0.5 to 0.7 g/ml after gassing is complete. In some embodiments, the density of the sensitized emulsion explosive is 0.7 to 0.9 g/ml.

The spray nozzle system 400 is configured to reestablish laminar flow of the sensitized emulsion explosive in the nozzle 700. When a chemical gassing agent, such as the second gassing agent 20, is used as the sensitizing agent, sensitization will typically occur over a period time and may not be complete until after the emulsion explosive is in the blasthole. For purposes of this disclosure, an emulsion explosive is referred to as “sensitized” once the sensitizing agent is mixed with the emulsion matrix. After being mixed by the static mixer 600, the sensitized emulsion explosive enters a central bore 710 of the nozzle 700. The central bore 710 of the nozzle 700 has a constant diameter from a nozzle inlet 720 to a nozzle outlet 730. The length of the nozzle 700 from the nozzle inlet 720 to the nozzle outlet 730 is configured during operation of the spray nozzle system 400 to establish laminar flow of the sensitized emulsion explosive. In other words, the static mixer 600 is disposed a predetermined distance from the nozzle outlet 730. The predetermined distance is determined so that the sensitized emulsion explosive recreates laminar flow before being ejected out of the nozzle outlet 730. In some embodiments, the length of the nozzle 700 equates with the predetermined distance of the static mixer 600 from the nozzle outlet 730. In some embodiments, the length of the nozzle 700 ranges from 25 mm to 100 mm. In some embodiments, the length of the nozzle 700 ranges from 35 mm to 80 mm.

After laminar flow of the sensitized emulsion explosive is established, the sensitized emulsion explosive is expelled from the nozzle outlet 730. The sensitized emulsion explosive is expelled from the nozzle outlet 730 at an angle that is less than 45 degrees from the longitudinal axis of the nozzle 700. In some embodiments, the sensitized emulsion explosive is expelled from the nozzle outlet 730 with either no angle or an angle between 0 degrees and 22.5 degrees. The sensitized emulsion explosive is generally sticky enough to stick to the walls of the blasthole 300 without needing to be expelled at an angle.

The expulsion of the sensitized emulsion explosive from the nozzle outlet 730 is configured to provide an axial thrust to retract the delivery apparatus 80 from the horizontal development blasthole 300. Since the sensitized emulsion explosive is expelled at an angle less than 45 degrees, a majority of the thrust created by the expulsion of the sensitized emulsion explosive from the nozzle outlet 730 is in the axial direction and not the radial direction. The axial force created by the expelled sensitized emulsion explosive is sufficient to retract the delivery apparatus 80 from the horizontal development blasthole 300. Accordingly, in some embodiments, there is no need to mechanically retract the delivery apparatus 80 from the horizontal development blasthole 300 during charging.

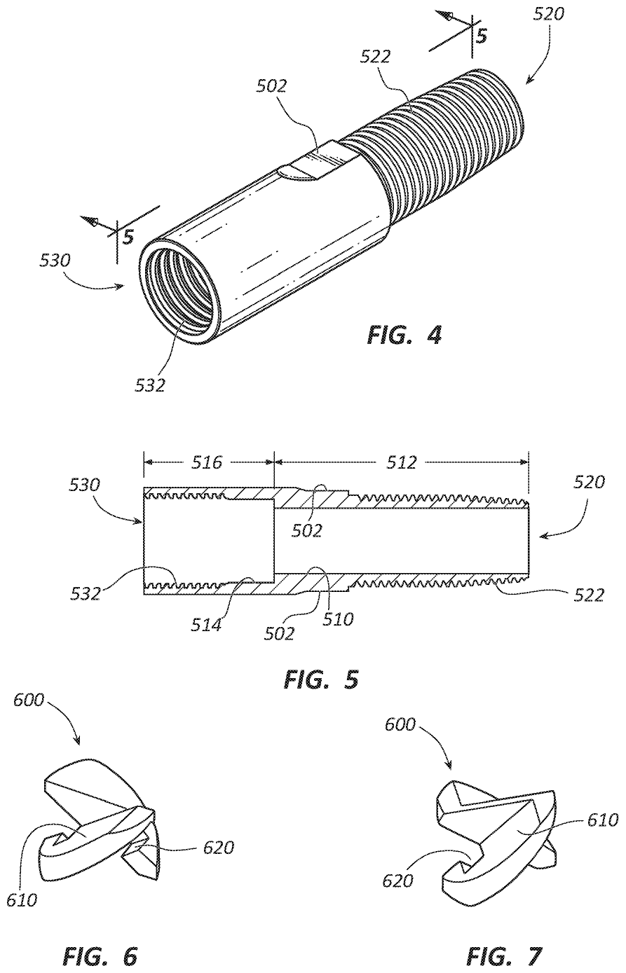

FIGS. 4 and 5 illustrate the mixing tube 500 of the spray nozzle system 400. FIG. 4 illustrates a perspective view of the mixing tube 500, and FIG. 5 illustrates a cross-sectional view of the mixing tube 500 taken along cross-sectional line 5-5. The mixing tube 500 comprises a tubular shape and may comprise a plurality of depressions 502 in a central region of the mixing tube 500. The illustrated embodiment of FIG. 4 only illustrates a single depression 502; however, a similar depression may be located on an opposite side of the mixing tube 500 that cannot be seen in FIG. 4. FIG. 5 illustrates the two depressions 502, with a first depression disposed on the top of the mixing tube 500 and a second depression disposed on the bottom of the mixing tube 500. The plurality of depressions 502 are configured to enable a user to grip the mixing tube 500 (with their hand or a tool, such as a wrench) and couple or attach the mixing tube 500 to the delivery apparatus 80 or the nozzle 700. While the illustrated embodiment of the mixing tube 500 of FIG. 5 illustrates two depressions 502, the mixing tube 500 may include more than two depressions 502. In one embodiment, the mixing tube 500 comprises four depressions that are equally spaced around the circumference of the mixing tube 500.

The outer surface of the mixing tube 500 near the mixing tube inlet 520 comprises a coupling mechanism 522 for coupling the mixing tube 500 to the delivery apparatus 80. The coupling mechanism 522 may comprise a plurality of threads that are configured to couple to corresponding threads disposed within the delivery apparatus 80 near the distal end 82 (e.g., outlet) of the delivery apparatus 80.

The central bore 510 of the mixing tube 500 extends from the mixing tube inlet 520 to the mixing tube outlet 530. The central bore 510 comprises two portions with differing diameters. A first portion 512 with a first diameter extends from the mixing tube inlet 520 to a shoulder 514. The second portion 516 extends from the shoulder 514 to the mixing tube outlet 530. The second portion 516 comprises the shoulder 514 and a coupling mechanism 532 to couple the mixing tube outlet 530 to the nozzle inlet 720. The coupling mechanism 532 may comprise a plurality of threads that are configured to couple to a corresponding coupling mechanism 722 (e.g., threads) on an outer surface of the nozzle inlet 720. In some embodiments, the diameter of the first portion 512 is less than the diameter of the second portion 516 and the shoulder 514.

The static mixer 600 is disposed within the central bore 510 of the mixing tube 500. As illustrated in FIG. 3, the static mixer 600 is disposed in the shoulder 514 of the central bore 510 of the mixing tube 500. In some embodiments, the static mixer 600 is removable from the shoulder 514 of the mixing tube 500 in order to clean the static mixer 600 due to a blockage in the spray nozzle system 400. The static mixer 600 may also be removed periodically for cleaning, or the static mixer 600 may be removed after each use for cleaning, and may be replaced after each use. The static mixer 600 may be temporarily secured to the shoulder 514 when the nozzle 700 is coupled to the mixing tube 500. The nozzle 700 may apply a friction fit to the static mixer 600 when the nozzle 700 is coupled to the mixing tube 500. When the static mixer 600 is temporarily secured in the shoulder 514, the static mixer 600 does not move in the axial direction nor does the static mixer 600 rotate.

In some embodiments, the static mixer 600 is fixedly coupled to the shoulder 514 of the central bore 510. Since the static mixer 600 is fixedly coupled to the shoulder 514, the static mixer 600 is unable to be removed from the mixing tube 500.

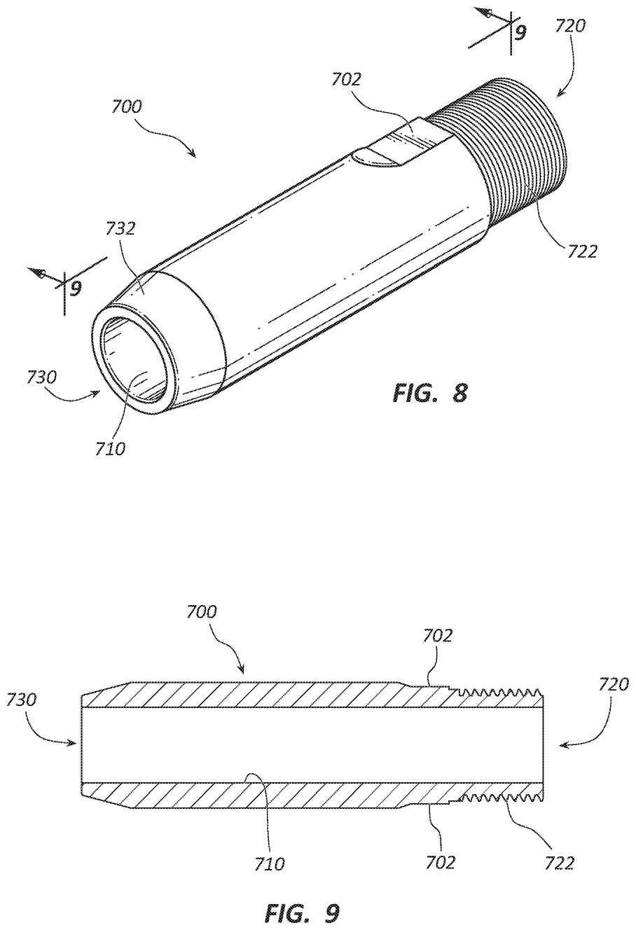

FIGS. 6 and 7 illustrate perspective views of the static mixer 600. In some embodiments, the static mixer 600 may include a plurality of mixing paths. The plurality of mixing paths are configured to disrupt the laminar flow of the emulsion matrix and substantially mix the sensitizing agent and the emulsion matrix to decrease the density and sensitize the emulsion matrix to create a sensitized emulsion explosive before the sensitized emulsion explosive is expelled out of the spray nozzle system 400. For example, FIGS. 6 and 7 include a first mixing path 610 and a second mixing path 620. The first mixing path 610 directs a portion of the emulsion matrix upward at an angle, laterally, and downward to a convergence point 630 and the second mixing path 620 directs the remaining emulsion matrix downward at an angle, laterally, and upward to the convergence point 630. The first mixing path 610 and the second mixing path 620 converge at the convergence point 630, where the first and second mixing paths 610, 620 converge and substantially mix the emulsion matrix and the sensitizing agent to decrease the density and sensitize the emulsion explosive.

FIGS. 8 and 9 illustrate the nozzle 700 of the spray nozzle system 400. FIG. 8 illustrates a perspective view of the nozzle 700 and FIG. 9 illustrates a cross-sectional view of the nozzle 700 taken along cross-sectional line 9-9. The nozzle 700 comprises a tubular shape and may comprise a plurality of depressions 702 in a central region of the nozzle 700. The illustrated embodiment of FIG. 8 only illustrates a single depression 702; however, a similar depression may be located on an opposite side of the nozzle 700 that cannot be seen in FIG. 8. FIG. 9 illustrates the two depressions 702, with a first depression disposed on the top of the nozzle 700 and a second depression 702 disposed on the bottom of the nozzle 700. The plurality of depressions 702 is configured to enable a user to grip the nozzle 700 (with their hand or a tool, such as a wrench) and couple or attach the nozzle 700 to the mixing tube 500. While the illustrated embodiment of the nozzle 700 of FIG. 8 illustrates two depressions 702, the nozzle 700 may include more than two depressions 702. In one embodiment, the nozzle 700 comprises four depressions that are equally spaced around the circumference of the nozzle 700.

The outer surface of the nozzle 700 near the nozzle inlet 720 comprises the coupling mechanism 722 (e.g., threads) for coupling the nozzle 700 to the mixing tube 500. The coupling mechanism 722 may comprise a plurality of threads that are configured to couple to corresponding coupling mechanism 532 (e.g., threads) disposed within the mixing tube 500 near the mixing tube outlet 530.

The central bore 710 of the nozzle 700 extends from the nozzle inlet 720 to the nozzle outlet 730. As discussed previously, the central bore 710 has a constant diameter. In some embodiments, the diameter of central bore 710 may be similar to the diameter of the first portion 512 of the central bore 510 of the mixing tube 500.

The nozzle 700 may further comprise a tapered region 732 near the nozzle outlet 730. The tapered region 732 tapers from an outer diameter of the nozzle 700 to a smaller diameter of the nozzle outlet 730.

The explosives delivery system 100 may be used to charge a horizontal blasthole in development charging. The substantially homogenized emulsion matrix may be pumped through a delivery apparatus 80 in laminar flow to the spray nozzle system 400 disposed at the end 82 of the delivery apparatus 80. The emulsion matrix may be mixed with the second gassing agent 20 in the mixing tube 500 with the static mixer 600 disposed within a central bore 510 of the mixing tube 500. The nozzle 700, which is coupled to the mixing tube 500, creates laminar flow in the sensitized emulsion explosive.

After laminar flow is created, the sensitized emulsion explosive may be expelled out of a nozzle outlet 730 at an angle less than 45 degrees. The expulsion of the sensitized emulsion explosive out of the nozzle outlet 730 may create axial thrust sufficient to retract the delivery hose while promoting efficient mixing and maintaining laminar flow.

In some embodiments, the delivery apparatus 80 does not include the spray nozzle system 400. FIG. 10 illustrates a process flow diagram of another embodiment of the explosives delivery system 100 for delivery explosives in development charging. As discussed above, the explosives delivery system 100 may be mounted on a mobile processing unit (not shown). The explosives delivery system 100 may include the first reservoir 10 to store the first gassing agent, the second reservoir 20 to store the second gassing agent, the third reservoir 30 to store the emulsion matrix, and the homogenizer 40. In some embodiments, the first reservoir 10, the second reservoir 20, the homogenizer 40, and combinations thereof may be optional components.

The explosives delivery system 100 may further include the delivery apparatus 80. As discussed above, the delivery apparatus 80 may have a central bore that extends a length of the delivery apparatus 80 from a proximal end to the distal end 82 of the delivery apparatus 80 and an outlet disposed at the distal end 82. In the illustrated embodiment, the delivery apparatus 80 does not include the spray nozzle system 400. Instead, a static mixer is disposed a predetermined distance of the distal end 82 or outlet of the delivery apparatus 80.

The explosives delivery system 100 may further include an additional static mixer 900 that mixes the emulsion matrix and the sensitizing agent before the emulsion explosive is introduced into the delivery apparatus 80. In this situation, the emulsion matrix may be sensitized before the end of hose static mixer 800.

The explosives delivery system 100 may further include a water injection system 1000 that injects a water ring into the delivery apparatus 80 to facilitate flow of the emulsion matrix along the delivery apparatus 80 by providing lubrication.

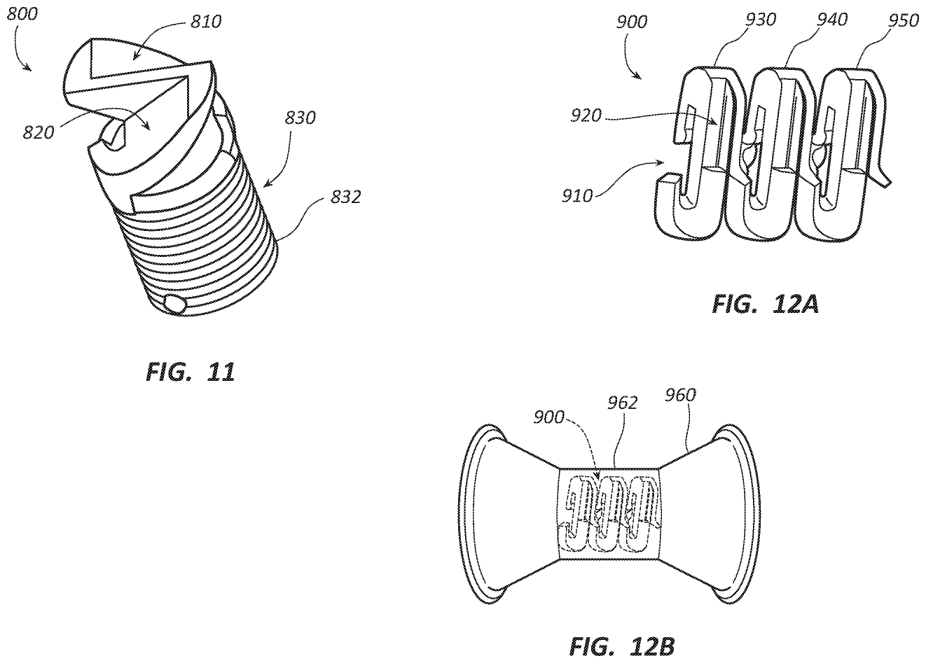

FIG. 11 illustrates the static mixer 800 that is disposed a predetermined distance from the distal end 82 or outlet of the delivery apparatus 80 and is configured to mix the second gassing agent and the emulsion matrix to sensitize the emulsion matrix. As discussed above, the delivery apparatus 80 may be a flexible hose. In some embodiments, the static mixer 800 may include a plurality of mixing paths 810, 820. The plurality of mixing paths 810 and 820 are configured to disrupt the laminar flow of the emulsion matrix and substantially mix the sensitizing agent and the emulsion matrix to decrease the density and sensitize the emulsion matrix to create a sensitized emulsion explosive before the sensitized emulsion explosive is expelled out of the distal end 82 or outlet of the delivery apparatus 80. A first mixing path 810 directs a portion of the emulsion matrix upward at an angle, laterally, and downward to a convergence point, and a second mixing path 820 directs the remaining emulsion matrix downward at an angle, laterally, and upward to the convergence point. The first mixing path 810 and the second mixing path 820 converge at the convergence point where the first and second mixing paths 810, 820 converge and substantially mix the emulsion matrix and the sensitizing agent to decrease the density and sensitize the emulsion.

The static mixer 800 may be coupled to a threaded tube 830 with a central bore and threads 832 on the external surface of the threaded tube 830. The threads 832 may extend the entire length of the threaded tube 830 or only a portion of the threaded tube 830. The static mixer 800 may be welded or otherwise coupled to a distal end of the threaded tube 830. In some embodiments, the static mixer 800 may be integral with the threaded tube 830. The threaded tube 830 may enable the static mixer 800 to be inserted and coupled to the delivery apparatus 80. In some embodiments, the delivery apparatus may be a delivery hose and the distal end 82 of the delivery hose may include internal threads that correspond with the threads 832 on the threaded tube 830. The static mixer 800 may then be screwed into the distal end 82 of the delivery apparatus 80 a predetermined distance to ensure that laminar flow is recreated after the static mixer 800 mixes the emulsion matrix and the sensitizing agent. In some embodiments, the predetermined distance ranges from 25 mm to 100 mm. In some embodiments, the predetermined distance ranges from 35 mm to 80 mm.

In some embodiments, the emulsion matrix and the sensitizing agent may be mixed to create a sensitized emulsion explosive before the emulsion explosive is introduced into the delivery apparatus 80. The mixing of the emulsion matrix and the sensitizing agent may be performed by the static mixer 900. FIG. 12A illustrates the static mixer 900 that is configured to mix the second gassing agent and the emulsion matrix to sensitize the emulsion matrix. In some embodiments, the static mixer 900 may include a plurality of mixing paths 910, 920. The plurality of mixing paths 910 and 920 are configured to disrupt the laminar flow of the emulsion matrix and substantially mix the sensitizing agent and the emulsion matrix to decrease the density and sensitize the emulsion matrix to create a sensitized emulsion explosive before the sensitized emulsion explosive. A first mixing path 910 directs a portion of the emulsion matrix upward at an angle, laterally, and downward to a convergence point, and a second mixing path 920 directs the remaining emulsion matrix downward at an angle, laterally, and upward to the convergence point. The first mixing path 910 and the second mixing path 920 converge at the convergence point where the first and second mixing paths 910, 920 converge and substantially mix the emulsion matrix and the sensitizing agent to decrease the density and sensitize the emulsion.

In the illustrated embodiments, the static mixer 900 is a three element static mixer. The static mixer 900 includes three distinct element 930, 940, 950 that each have a similar designs. Each element 930, 940, 950 includes the first and second mixing paths 910, 920, thus creating a tortuous pathway for mixing the emulsion matrix and the sensitizing agent.

FIG. 12B illustrates the static mixer 900 disposed within pipework 960. A center portion 962 of the pipework 960 may house the static mixer 900 (shown in phantom lines). The pipework 960 may comprise flared ends that flare out from the center portion 962 with an increasing diameter as the flared ends extend away from the center portion 962. The center portion 962 of the pipework 960 may have a diameter of one inch.

Experimental Results

The tables below summarize experiments conducted with an underground mobile processing unit. The nozzle system was manufactured out of a standard uphole spray nozzle by enlarging a spray hole using a 13 mm drill bit. The initial results showed a remarkable increase in gassing efficiency. Since the molar intakes of gassing reagent were known and the densities of the emulsion matrix before and after gassing were determined, the gassing efficiency was estimated using the Ideal Gas Law to calculate the theoretical gas volume and Charles's law to compensate for the temperature differences during charging.

Ideal Gas Law: P×V=n×R×T (P, V, and T are the pressure, volume, and temperature, n is the amount of substance, and R is the ideal gas constant)

Charles's law:

$${V}_{T} = {V}_{0} + ( \frac{1}{273} ) \times {V}_{0} \times T ( V in liters , T in Kelvin )$$

TABLE 1
Gassing efficiencies using a development delivery system with
and without the improvised nozzle. Gassing efficiencies were
calculated after 30 minutes of gassing the emulsion explosive.

| | | | Density | |
|---|---|---|---|---|
| | Gassing | Density | emulsion | |
| | reagent | emulsion | after | |
| | added | before | 30 minutes | Gassing |
| | (wt % of | gassing | gassing | efficiency |
| System | emulsion) | (g/ml) | (g/ml) | (%) |
| No nozzle | 1.0 | 1.3 | 1.2 | 7.7 |
| attached | | | | |
| No nozzle with 4- | 1.0 | 1.3 | 1.1 | 13.2 |
| element static | | | | |
| mixer | | | | |
| Improvised | 1.0 | 1.3 | 0.6 | 73.2 |
| nozzle | | | | |
| Improvised | 0.2 | 1.3 | 1.1 | 48.8 |
| nozzle with lower | | | | |
| gassing flow | | | | |

After this initial test, a spray nozzle system was designed based on the disclosed spray nozzle system 400 to include a nozzle 700 coupled to the mixing tube 500 to establish laminar flow after mixing. Differing lengths of the nozzle 700 were used.

TABLE 2
Gassing efficiencies using the spray nozzle system
400. Gassing efficiencies were calculated after
30 minutes of gassing the explosive emulsion.

| | | | Density | |
|---|---|---|---|---|
| | Gassing | Density | emulsion | |
| | reagent | emulsion | after | |
| | added | before | 30 minutes | Gassing |
| | (wt % of | gassing | gassing | efficiency |
| System | emulsion) | (g/ml) | (g/ml) | (%) |
| No nozzle | 1.4 | 1.3 | 1.0 | 21.6 |
| attached | | | | |
| Nozzle length 35 | 0.3 | 1.3 | 1.1 | 67.5 |
| mm | | | | |
| Nozzle length 70 | 0.3 | 1.3 | 1.1 | 69.6 |
| mm | | | | |
| Nozzle length 70 | 0.8 | 1.3 | 0.7 | 94.2 |
| mm with lower | | | | |
| gassing flow | | | | |

The spray nozzle system 400 achieves gassing efficiencies of up to three to four times higher. With the spray nozzle system 400 installed and an intake of only 0.8 wt % of gassing reagent, a low emulsion density of 0.7 g/ml was achieved. These results were unexpected and cannot be achieved with current technology.

TABLE 3
Gassing efficiencies using the static mixer 800 disposed 100
mm from the distal end 82 of the delivery apparatus 80 (e.g.
delivery hose) with a 19 mm internal diameter and the pre-
hose static mixer 900. Gassing efficiencies were calculated
after 30 minutes of gassing the emulsion explosive.

| | | | Density | |
|---|---|---|---|---|
| | Gassing | Density | emulsion | |
| | reagent | emulsion | after | |
| | added | before | 30 minutes | Gassing |
| | (wt % of | gassing | gassing | efficiency |
| System | emulsion) | (g/ml) | (g/ml) | (%) |
| A | 0.629 | 1.330 | 0.754 | 55.2 |
| B | 0.616 | 1.330 | 0.730 | 58.1 |
| C | 0.320 | 1.330 | 0.928 | 59.7 |

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

1. An explosives delivery system comprising:
a reservoir configured to store a sensitizing agent;
a reservoir configured to store an emulsion matrix;
a delivery apparatus having a central bore that extends a length of the delivery apparatus from a proximal end to the distal end of the delivery apparatus and an outlet disposed at the distal end, wherein the delivery apparatus is configured to deliver an emulsion explosive out of the outlet of the delivery apparatus; and
a static mixer disposed within the central bore of the delivery apparatus a predetermined distance from the outlet of the delivery apparatus, wherein the static mixer is configured to mix the emulsion matrix and the sensitizing agent in the delivery apparatus into the emulsion explosive,
wherein the predetermined distance of the static mixer from the outlet of the delivery apparatus is of sufficient length of the central bore to establish laminar flow of the emulsion explosive after the emulsion is mixed by the static mixer.

2. The explosives delivery system of claim 1, wherein the predetermined distance ranges from 25 mm to 100 mm.

3. The explosives delivery system of claim 1 or claim 2, wherein the predetermined distance ranges from 35 mm to 80 mm.

4. The explosives delivery system of any one of claims 1-3, wherein the emulsion matrix is a homogenized emulsion matrix.

5. The explosives delivery system of any of the claims 1-4, wherein the sensitizing agent is a chemical gassing agent.

6. The explosives delivery system of any one of claims 1-5, wherein the delivery apparatus comprises a delivery hose with a central bore and an outlet, wherein the static mixer is disposed within the central bore of the delivery hose the predetermined distance from the outlet of the delivery hose.

7. The explosives delivery system of claim 6, wherein the static mixer is coupled to a top of a threaded tube, wherein threads of the threaded tube are disposed on an outer surface of the threaded tube and is configured to thread into the delivery hose the predetermined distance from the outlet of the delivery hose.

8. The explosives delivery system of claim 6 or claim 7, wherein the static mixer is couplable within the central bore of the delivery hose the predetermined distance from the outlet of the delivery hose via a clamp that clamps the static mixer in place on the outside of the delivery hose.

9. The explosives delivery system of any one of claims 1-5, wherein the delivery apparatus comprises:
a mixing tube comprising a central bore that extends from a mixing tube inlet to a mixing tube outlet, wherein the mixing tube inlet is configured to couple to an outlet of a delivery hose, and wherein the static mixing is disposed within the central bore of the mixing tube; and
a nozzle comprising a central bore that extends from a nozzle inlet to a nozzle outlet, wherein the nozzle inlet is coupled to the mixing tube outlet, and a length of the nozzle is the predetermined distance.

10. The explosives delivery system of claim 9, wherein an inner diameter of the mixing tube inlet is smaller than an inner diameter of the mixing tube outlet.

11. The explosives delivery system of claim 9 or claim 10, wherein the static mixer is disposed within a shoulder of the central bore of the mixing tube.

12. The explosives delivery system of any one of claims 9-11, wherein the mixing tube comprises threading on an outer surface of the mixing tube inlet that is configured to couple to corresponding threads of the outlet of the delivery hose.

13. The explosives delivery system of any one of claims 9-12, wherein the nozzle is detachably attachable to the mixing tube.

14. The explosives delivery system of any one of claims 9-13, wherein the mixing tube comprises threads on an inner surface of the mixing tube outlet and the nozzle comprises corresponding threads on an outer surface of the nozzle inlet, wherein the threads are configured to couple to each other.

15. The explosives delivery system of any one of claims 1-5 and 9-14, wherein the inner diameter of the central bore of the nozzle is constant from the nozzle inlet to the nozzle outlet.

14. The explosives delivery system of any one of claims 1-15, wherein the emulsion explosive is expelled from the outlet of the delivery apparatus at an angle less than 45 degrees of the longitudinal axis of the delivery apparatus.

17. The explosives delivery system of any one of claims 1-16, further comprising a second static mixer that is configured to partially mix the emulsion matrix with the sensitizing agent before the emulsion matrix enters the delivery apparatus.

18. The explosives delivery system of claim 17, wherein the second static mixer is a three-element static mixer.

19. A method of development charging comprising:
delivering an emulsion matrix through a central bore of a delivery apparatus, the delivery apparatus having a central bore that extends a length of the delivery apparatus from a proximal end to the distal end and an outlet disposed at the distal end;
mixing the emulsion matrix with a sensitizing agent in the delivery apparatus with a static mixer disposed within the central bore of the delivery apparatus a predetermined distance from an outlet of the delivery apparatus to form a sensitized emulsion explosive; and
creating laminar flow in the sensitized emulsion explosive after mixing before the sensitized emulsion is expelled from the outlet of the delivery apparatus.

20. The method of claim 19, expelling the sensitized emulsion explosive out of the outlet of the delivery apparatus at an angle less than 45 degrees.

21. The method of claim 19 or claim 20, wherein expulsion of the sensitized emulsion explosive out of the outlet creates axial thrust sufficient to retract the delivery apparatus while promoting efficient mixing and maintaining laminar flow.

22. The method of any one of claims 19-21, further comprising retracting the delivery apparatus from a development bore hole.

23. The method of any one of claims 19-22, wherein a density of the expelled sensitized emulsion explosive reaches 0.9 g/ml.

24. The method of any one of claims 19-23, wherein a density of the expelled sensitized emulsion explosive is 0.5 to 0.7 g/ml.

25. The method of any one of claims 19-24, wherein the predetermined distance ranges from 25 mm to 100 mm.

26. The method of any one of claims 19-25, wherein the predetermined distance ranges of 35 mm to 80 mm.

27. The method of any one of claims 19-26, wherein the delivery apparatus comprises a delivery hose with a central bore and an outlet, wherein the static mixer is disposed within the central bore of the delivery hose the predetermined distance from the outlet of the delivery hose.

28. The method of any one of claims 19-27, further comprising mixing the emulsion before the emulsion enters the delivery apparatus with a second static mixer.

29. An explosives delivery system comprising:
a reservoir configured to store a sensitizing agent;
a reservoir configured to store an emulsion matrix;
a delivery hose having a central bore that extends a length of the delivery hose from a proximal end to the distal end of the delivery hose and an outlet disposed at the distal end, wherein the delivery apparatus is configured to deliver an emulsion explosive out of the outlet of the delivery apparatus;
a pre-hose static mixer configured to mix the emulsion matrix and the sensitizing agent to create a sensitize emulsion explosive before the sensitized emulsion explosive is introduced into the delivery hose; and
an end of hose static mixer disposed within the central bore of the delivery hose a predetermined distance from the outlet of the delivery apparatus, wherein the end of hose static mixer is configured to remix the sensitized emulsion explosive.

30. The explosives delivery system of claim 29, further comprising a homogenizer configured to homogenize the emulsion matrix before the mixing of the pre-hose static mixer.

31. The explosives delivery system of any one of claims 29-30, wherein a density of the expelled sensitized emulsion explosive reaches 0.9 g/ml.

32. The explosives delivery system of any one of claims 29-31, wherein a density of the expelled sensitized emulsion explosive is between 0.5 to 0.7 g/ml.

33. The explosives delivery system of any one of claims 29-31, wherein a density of the expelled sensitized emulsion explosive is between 0.7 to 0.9 g/ml.

34. The explosives delivery system of any one of claims 29-33, wherein the sensitized emulsion matrix achieves at least 55 percent gassing efficiency as the sensitized emulsion matrix is expelled from the delivery hose.
